(19) United States
(12) Patent Application Publication
(10) Pub. No.: US 2023/0370659 A1
(43) Pub. Date: Nov. 16, 2023

(54) METHOD, DEVICE, AND COMPUTER PROGRAM FOR OPTIMIZING INDEXING OF PORTIONS OF ENCAPSULATED MEDIA CONTENT DATA

(71) Applicant: CANON KABUSHIKI KAISHA, Tokyo (JP)

(72) Inventors: Frédéric MAZE, LANGAN (FR); Franck DENOUAL, SAINT DOMINEUC (FR); Jean LE FEUVRE, GOMETZ-LE-CHATEL (FR)

(21) Appl. No.: 18/029,050

(22) PCT Filed: Sep. 28, 2021
(86) PCT No.: PCT/EP2021/076714

§ 371 Date: Mar. 28, 2023

(30) Foreign Application Priority Data
Sep. 29, 2020 (GB) 2015413.4

(51) Int. Cl. H04N 21/2389; H04N 21/235; H04N 21/84

(52) U.S. Cl. CPC H04N 21/2389; H04N 21/235; H04N 21/84

(57) ABSTRACT

A method for encapsulating media data, the media data comprising metadata and data associated with the metadata, the metadata being descriptive of the associated data, the media data comprising a plurality of segments, at least one segment comprising a plurality of sub-segments. For a plurality of byte ranges of at least one of the sub-segments, associating one level value with each byte range within metadata descriptive of partial sub-segments of the at least one of the sub-segments, wherein the metadata descriptive of partial sub-segments of the at least one of the sub-segments further comprise a feature type value representative of features associated with level values.

### FIELD OF THE INVENTION

The present invention relates to a method, a device, and a computer program for improving encapsulating and parsing of media data, making it possible to optimize the indexing and transmission of portions of encapsulated media content data.

### BACKGROUND OF THE INVENTION

The invention relates to encapsulating, parsing, and streaming media content data, e.g. according to ISO Base Media File Format as defined by the MPEG standardization organization, to provide a flexible and extensible format that facilitates interchange, management, editing, and presentation of group of media content and to improve its delivery for example over an IP network such as the Internet using adaptive http streaming protocol.

The International Standard Organization Base Media File Format (ISO BMFF, ISO/IEC 14496-12) is a well-known flexible and extensible format that describes encoded timed media content data or bit-streams either for local storage or transmission via a network or via another bit-stream delivery mechanism. This file format has several extensions, e.g. Part-15, ISO/IEC 14496-15 that describes encapsulation tools for various NAL (Network Abstraction Layer) unit-based video encoding formats. Examples of such encoding formats are AVC (Advanced Video Coding), SVC (Scalable Video Coding), HEVC (High Efficiency Video Coding), L-HEVC (Layered HEVC), or VVC (Versatile Video Coding). This file format is object-oriented. It is composed of building blocks called boxes (or data structures, each of which being identified by a four character code) that are sequentially or hierarchically organized and that define descriptive parameters of the encoded timed media content data or bit-stream such as timing and structure parameters. In the file format, the overall presentation over time is called a movie. The movie is described by a movie box (with four character code ‘moov’) at the top level of the media or presentation file. This movie box represents an initialization information container containing a set of various boxes describing the presentation. It may be logically divided into tracks represented by track boxes (with four character code ‘trak’). Each track (uniquely identified by a track identifier (track_ID)) represents a timed sequence of media content data pertaining to the presentation (frames of video, for example). Within each track, each timed unit of media content data is called a sample; this might be a frame of video, a sample of audio, or a set of timed metadata. Samples are implicitly numbered in sequence. The actual samples data are in boxes called Media Data boxes (with four character code ‘mdat’) or Identified Media Data boxes (with four character code ‘imda’) at the same level as the movie box. The movie may also be fragmented, i.e. organized temporally as a movie box containing information for the whole presentation followed by a list of movie fragment and Media Data box pairs or movie fragment and Identified Media Data box pairs. Within a movie fragment (box with four-character code ‘moof’) there is a set of track fragments (box with four character code ‘traf’), zero or more per movie fragment. The track fragments in turn contain zero or more track run boxes (‘trun’), each of which documents a contiguous run of samples for that track fragment.

Media data encapsulated with ISOBMFF can be used for adaptive streaming with HTTP. For example, MPEG DASH (for “Dynamic Adaptive Streaming over HTTP”) and Smooth Streaming are HTTP adaptive streaming protocols enabling segment or fragment based delivery of media files. In the following, it is considered that media data designate encapsulated data comprising metadata and media content data (the latter designating the bit-stream that is encapsulated). The MPEG DASH standard (see “ISO/IEC 23009-1, Dynamic adaptive streaming over HTTP (DASH), Part1: Media presentation description and segment formats”) makes it possible to establish a link between a compact description of the content(s) of a media presentation and the HTTP addresses. Usually, this association is described in a file called a manifest file or description file. In the context of DASH, this manifest file is a file also called the MPD file (for Media Presentation Description). When a client device gets the MPD file, the description of each encoded and deliverable version of media content can easily be determined by the client. By reading or parsing the manifest file, the client is aware of the kind of media content components proposed in the media presentation and is aware of the HTTP addresses for downloading the associated media content components. Therefore, it can decide which media content components to download (via HTTP requests) and to play (decoding and playing after reception of the media data segments). DASH defines several types of segments, mainly initialization segments, media segments, or index segments. Initialization segments contain setup information and metadata describing the media content, typically at least the ‘ftyp’ and ‘moov’ boxes of an ISOBMFF media file. A media segment contains the media data. It can be for example one or more ‘moof’ plus ‘mdaf’ or ‘imda’ boxes of an ISOBMFF file or a byte range in the ‘mdat’ or ‘imda’ box of an ISOBMFF file. A media segment may be further subdivided into sub-segments (also corresponding to one or more complete ‘moof’ plus ‘mdaf’ or ‘imda’ boxes). The DASH manifest may provide segment URLs or a base URL to the file with byte ranges to segments for a streaming client to address these segments through HTTP requests. The byte range information may be provided by index segments or by specific ISOBMFF boxes such as the Segment Index box ‘sidx’ or the SubSegment Index box ‘ssix’.

FIG. 1 illustrates an example of streaming media data from a server to a client.

As illustrated, a server 100 comprises an encapsulation module 105 connected, via a network interface (not represented), to a communication network 110 to which is also connected, via a network interface (not represented), a de-encapsulation module 115 of a client 120.

Server 100 processes data, e.g. video and/or audio data, for streaming or for storage. To that end, server 100 obtains or receives data comprising, for example, an original sequence of images 125, encodes the sequence of images into media content data (or bit-stream) using a media encoder (e.g. video encoder), not represented, and encapsulates the media content data in one or more media files or media segments 130 using encapsulation module 105. The encapsulation process consists in storing the media content data in ISOBMFF boxes and generating and/or storing associated metadata describing the media content data. Encapsulation module 105 comprises at least one of a writer or a packager to encapsulate the media content data. The media encoder may be implemented within encapsulation module 105 to encode received data or may be separate from encapsulation module 105.

Client 120 is used for processing data received from communication network 110, or read from a storage device, for example for processing media file 130. After the received data have been de-encapsulated in de-encapsulation module 115 (also known as a parser), the de-encapsulated data (or parsed data), corresponding to a media content data or bit-stream, are decoded, forming, for example, audio and/or video data that may be stored, rendered (e.g. play or display) or output. The media decoder may be implemented within de-encapsulation module 115 or it may be separate from de-encapsulation module 115. The media decoder may be configured to decode one or more media content data or bit-streams in parallel.

It is noted that media file 130 may be communicated to de-encapsulation module 115 in different ways. In particular, encapsulation module 105 may generate media file 130 with a media description (e.g. DASH MPD) and communicates (or streams) it directly to de-encapsulation module 115 upon receiving a request from client 120.

For the sake of illustration, media file 130 may encapsulate media content data (e.g. encoded audio or video) into boxes according to ISO Base Media File Format (ISOBMFF, ISO/IEC 14496-12 and ISO/IEC 14496-15 standards). In such a case, media file 130 may correspond to one or more media files (indicated by a FileTypeBox ‘ftyp’), as illustrated in FIG. 2, or one or more segment files corresponding to one initialization segment (when indicated by a FileTypeBox ‘ftyp’) or one or more media segments (when indicated by a SegmentTypeBox ‘styp’), as illustrated in FIGS. 3a and 3b. Optionally the segment files may also contain one or more Segment Index boxes ‘sidx’ and SubSegment Index boxes ‘ssix’ providing indexation information on media segments. According to ISOBMFF, media file 130 may include two kinds of boxes, “media data boxes” (e.g. ‘mdaf’ or ‘imda’) containing the media content data and “metadata boxes” (e.g. ‘moov’, ‘moof’, ‘sidx’, ‘ssix’) containing metadata defining placement and timing of the media content data.

FIG. 2 illustrates an example of data encapsulation in a media file. As illustrated, media file 200 contains a ‘moov’ box 205 providing metadata to be used by a client during an initialization step. For the sake of illustration, the items of information contained in the ‘moov’ box may comprise the number of tracks present in the file as well as a description of the samples contained in the file. According to the illustrated example, the media file further comprises a segment index box ‘sidx’ 210, a sub-segment index box ‘ssix’ 215 and several fragments such as fragments 220 and 225, each composed of a metadata part and a media content data part. For example, fragment 220 comprises metadata represented by ‘moof’ box 230 and media content data part represented by ‘mdat’ box 235. Segment index box ‘sidx’ 210 documents how the file is divided into one or more sub-segments (i.e. into one or more segment byte ranges), each sub-segment being composed of a complete set of fragments. It comprises an index making it possible to reach directly data associated with a particular sub-segment. It comprises, in particular, the duration and size of the sub-segment. Sub-segment index box ‘ssix’ 215 documents how a sub-segment is divided into one or more partial sub-segments (i.e. into one or more sub-segment byte ranges). It comprises an index making it possible to reach data of a sub-segment and a mapping of data byte ranges to levels. Levels are documented by a Level Assignment Box ‘leva’ located within the Movie box ‘moov’ 205. The file 200 may include a chain of multiple segment index boxes ‘sidx’ and sub-segment index boxes ‘ssix’.

FIG. 3a and FIG. 3b illustrate an example of data encapsulation as a media segment or as segments, being observed that media segments are suitable for live streaming.

FIG. 3a illustrates the first segment of encapsulated media data. It is an initialization segment 300 that begins with the ‘ftyp’ box with a ‘moov’ box 305 indicating the presence of movie fragments (with a box ‘mvex’, not represented), the initialization segment may comprise index information (‘sidx’ and ‘ssix’ boxes) and/or movie fragments or not. When a Sub-segment index box ‘ssix’ is defined in one of segments, a Level Assignment Box ‘leva’ is declared within the Movie box ‘moov’ to document the levels.

FIG. 3b illustrates subsequent media segments of encapsulated media data. As illustrated, media segment 350 begins with the ‘styp’ box. It is noted that for using segments like segment 350, an initialization segment 300 must be available. According to the example illustrated in FIG. 3b, media segment 350 contains one segment index box ‘sidx’ 355, one sub-segment index box ‘ssix’ 360 and several fragments such as fragments 365 and 370. Segment index box ‘sidx’ 355 documents how the segment is divided into one or more sub-segments, each sub-segment being composed of a complete set of fragments. For example, each of the fragments 365 and 370 may represent a sub-segment or the combination of fragments 365 and 370 may represent one single sub-segment. Segment index box ‘sidx’ 355 comprises an index making it possible to reach directly data associated with a particular sub-segment. It comprises, in particular, the duration and size of the sub-segment. Sub-segment index box ‘ssix’ 360 documents how a sub-segment is divided into one or more partial sub-segments. It comprises an index making it possible to reach data of a partial sub-segment and a mapping of data byte ranges to levels. Levels are documented by a level assignment box ‘leva’ located within movie box ‘moov’ 305. Multiple segment index boxes ‘sidx’ and sub-segment index boxes ‘ssix’ can be defined and organised as a daisy-chain of boxes. When a segment beginning with a ‘styp’ box only contains index boxes (e.g. ‘sidx’, ‘ssix’), it is called an index segment. Again, each fragment is composed of a metadata part and a media content data part. For example, fragment 365 comprises metadata represented by ‘moof’ box 375 and media content data part represented by ‘mdat’ box 380.

FIG. 4a and FIG. 4b illustrate the indexation of a media segment using a segment index box ‘sidx’ and a sub-segment index box ‘ssix’.

FIG. 4a illustrates an example of the segment index box ‘sidx’, referenced 400, similar to those represented in FIGS. 2 and 3b, as defined by ISO/IEC 14496-12 in a simple mode wherein an index provides durations and sizes for two sub-segments. For the sake of illustration, the first sub-segment, referenced 430, is composed of one fragment and the second sub-segment, referenced 435, is composed of two fragments encapsulated in the corresponding file or segment. When the reference_type field referenced 405 is set to zero, the simple index, described within ‘sidx’ box 400, consists in a loop on the sub-segments contained in the segment. Each entry in the index (e.g. entries referenced 420 and 425) provides the size in bytes and the duration of a sub-segment as well as information on whether the sub-segment is beginning with a random access point or not. For example, entry 420 in the index provides the size referenced 410 and the duration referenced 415 of sub-segment 430.

FIG. 4b illustrates an example of the sub-segment index box ‘ssix’, referenced 450, similar to those represented in FIGS. 2 and 3b, as defined by ISO/IEC 14496-12. A sub-segment index box ‘ssix’ must be the next box after the associated segment index box ‘sidx’. For each sub-segment described by the associated segment index box ‘sidx’ (e.g. entry 455 or 460), it documents how the sub-segment (e.g. entry 465 or 470) is divided into one or more partial sub-segments. The subsegment_count parameter is equal to the reference_count parameter in the associated segment index box (i.e. the loop entries 455 and 465 are related to the same sub-segment 475 and the loop entries 460 and 470 are related to the same other sub-segment 480). According to the example illustrated in FIG. 4b, sub-segment 480 corresponding to loop entries 460 and 470 is divided into two partial sub-segments corresponding to the second loop entries 485 and 490. Each entry in the second loop (e.g. entries denoted 485 and 490) provides the size in bytes of the partial sub-segments (denoted RSⱼ and RSⱼ₊₁ in FIG. 4b) and an associated level (denoted Lⱼ and Lⱼ₊₁ in FIG. 4b). Each byte of the sub-segment is explicitly assigned to a partial sub-segment. The data range corresponding to a partial sub-segment may include both movie fragment boxes ‘moof’ and media data boxes ‘mdaf’ or ‘imda’. The first partial sub-segment, i.e. the partial sub-segment the lowest level is assigned to, corresponds to a movie fragment box as well as (parts of) media data box(es), whereas subsequent partial sub-segments (to which higher levels are assigned) may correspond to (parts of) media data box(es) only. Data byte ranges for one given level are contiguous.

In the example illustrated in FIG. 4b, the first partial sub-segment of sub-segment 480 includes a movie fragment box ‘moof’, the beginning of a media data box ‘mdat’ and the data of the first frame (denoted ‘I’ for Intra frame). The second partial sub-segment is only a part of a media data box beginning after the last byte of the data corresponding to the ‘I’ frame up to the end of the sub-segment.

It is recalled that levels represent specific features of subsets of the media content data or bit-stream (e.g. scalability layers) and obeys to the following constraint: samples corresponding to level n may only depend on samples of levels m, where m is smaller than or equal n. The feature actually associated with a given level value is determined from the level assignment box ‘leva’ located into the movie box ‘moov’. For each level, the level assignment box ‘leva’ provides an assignment type. This assignment type indicates the mechanism used to specify the assignment of a feature to a level. For the sake of illustration, the assignment of levels to partial sub-segments (i.e. to byte ranges) may be based on sample groups, tracks, or sub-tracks:
sample groups may be used to specify levels, i.e., samples mapped to different sample group description indexes of a particular sample grouping lie in different levels within the identified track (e.g. temporal level sample group ‘tele’ or stream access point sample group ‘sap’);
tracks can be used for instance when audio and video movie fragments (including the respective media data boxes) are interleaved, and
sub-tracks make it possible to identify the samples of a sub-track.

While these file formats and these methods for transmitting media data have proven to be efficient, there is a continuous need to improve selection of the data to be sent to a client while reducing the complexity of the description of the indexation, reducing the requested bandwidth, and taking advantage of the increasing processing capabilities of the client devices.

The present invention has been devised to address one or more of the foregoing concerns.

### SUMMARY OF THE INVENTION

The present invention has been devised to address one or more of the foregoing concerns.

In this context, there is provided a solution for improving indexing of portions of encapsulated media content data.

According to a first aspect of the invention there is provided a method for encapsulating media data, the media data comprising metadata and data associated with the metadata, the metadata being descriptive of the associated data, the media data comprising a plurality of segments, at least one segment comprising a plurality of sub-segments, the method being carried out by a server and comprising:
for a plurality of byte ranges of at least one of the sub-segments, associating one level value with each byte range within metadata descriptive of partial sub-segments of the at least one of the sub-segments,
wherein the metadata descriptive of partial sub-segments of the at least one of the sub-segments further comprise a feature type value representative of features associated with level values

Accordingly, the method of the invention makes it possible to improve indexing of encapsulated data and thus, to improve data transmission efficiency and versatility.

According to some embodiments, a same level value is associated with at least two non-contiguous byte ranges of the at least one of the sub-segments.

According to some embodiments, the feature type value indicates that the features associated with level values are defined within metadata descriptive of data of the segments.

According to some embodiments, the feature type value indicates that the level values are representative of dependency levels.

According to some embodiments, the feature type value indicates that the level values are representative of track dependency levels. A track identifier may be associated with a level value.

According to some embodiments,
a first level value indicates that the corresponding byte range contains only metadata,
a second level value indicates that the corresponding byte range comprises metadata and data, the data being independently decodable,
a third level value indicates that the corresponding byte range contains only data that are independently decodable, and/or
a fourth level value indicates that the data of the corresponding byte range require data of a byte range associated with a lower level value to be decoded.

According to some embodiments, the feature type value indicates that the level values are representative of data integrity of data of the corresponding byte range.

According to some embodiments, the metadata descriptive of partial sub-segments of the at least one of the sub-segments further comprise a flag indicating that an end portion of a byte range can be ignored for decoding the encapsulated media data.

According to some embodiments, the feature type value is a first feature type value, the at least one of the sub-segments being referred to as a first sub-segment, metadata descriptive of partial sub-segments of the sub-segments further comprising a second feature type value representative of features associated with level values of a second sub-segment of the at least one segment, different from the first sub-segment.

According to some embodiments, the metadata descriptive of partial sub-segments of the at least one of the sub-segments belong to a box of the ‘ssix’ type, the media data being encapsulated according to ISOBMFF. The metadata descriptive of data of the segments may belong to a box of the ‘leva’ type.

According to a second aspect of the invention there is provided a method for transmitting media data, the media data comprising metadata and data associated with the metadata, the metadata being descriptive of the associated data, the media data comprising a plurality of segments, at least one segment comprising a plurality of sub-segments, the method comprising encapsulating the media data according to the method described above.

According to a third aspect of the invention there is provided a method for processing received encapsulated media data, the media data being encapsulated according to the method described above.

The method of the second and third aspect of the invention makes it possible to improve indexing of encapsulated data and thus, to improve data transmission efficiency and versatility.

According to a fourth aspect of the invention there is provided a method for processing received encapsulated media data, the media data comprising metadata and data associated with the metadata, the metadata being descriptive of the associated data, the media data comprising a plurality of segments, at least one segment comprising a plurality of sub-segments, the method being carried out by a client and comprising:
for a plurality of byte ranges of at least one of the sub-segments, the byte ranges being defined in metadata descriptive of partial sub-segments of the at least one of the sub-segments, obtaining one level value associated with each byte range within the metadata descriptive of partial sub-segments of the at least one of the sub-segments,
obtaining a feature type value representative of features associated with level values, the feature type value being obtained from the metadata descriptive of partial sub-segments of the at least one of the sub-segments, and
processing byte ranges of the plurality of byte ranges according to a feature determined from the obtained feature type value

Accordingly, the method of the invention makes it possible to improve indexing of encapsulated data and thus, to improve data transmission efficiency and versatility.

According to a fifth aspect of the invention there is provided a device for encapsulating, transmitting, or receiving encapsulated media data, the device comprising a processing unit configured for carrying out each of the steps of the method described above.

The fifth aspect of the present invention has advantages similar to those mentioned above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates an example of streaming media data from a server to a client;

FIG. 2 illustrates an example of data encapsulation in a media file;

FIG. 3a illustrates an example of data encapsulation as an initialization segment;

FIG. 3b illustrates an example of data encapsulation as a media segment or as segments;

FIG. 4a illustrates a segment index box ‘sidx’ such as those represented in FIGS. 2 and 3b, as defined by ISO/IEC 14496-12 in a simple mode wherein an index provides durations and sizes for each sub-segment encapsulated in the corresponding file or segment;

FIG. 4b illustrates a sub-segment index box ‘ssix’ such as those represented in FIGS. 2 and 3b, as defined by ISO/IEC 14496-12 wherein an index provides sizes and associated level for each partial sub-segment encapsulated in a sub-segment described by a segment index box ‘sidx’;

FIG. 5 illustrates requests and responses between a server and a client, as performed with DASH, to obtain media data;

FIG. 6 is a block diagram illustrating an example of steps carried out by a server to transmit data to a client according to some embodiments of the invention;

FIG. 7 is a block diagram illustrating an example of steps carried out by a client to obtain data from a server according to some embodiments of the invention;

FIG. 8 illustrates an extended level assignment box ‘leva’ according to some embodiments of the invention;

FIG. 9 illustrates an extended sub-segment index box ‘ssix’ according to some embodiments of the invention;

FIG. 10 is a block diagram illustrating an example of steps carried out by a client to interpret the level assigned to byte ranges according to some embodiments of the invention;

FIG. 11a, FIGS. 11b, and 11c illustrate three different examples of level assignment using an extended sub-segment index box ‘ssix’ according to some embodiments of the invention;

FIGS. 12a, 12b, and 12c illustrate three different examples of multi-track level assignment using an extended sub-segment index box ‘ssix’ according to some embodiments of the invention;

FIG. 13 illustrates an example of signalling corrupted timed media content data according to some embodiments of the invention;

FIG. 14 is a block diagram illustrating an example of steps carried out by a processing device to generate a media file comprising corrupted timed media content data according to some embodiments of the invention; and

FIG. 15 is a block diagram illustrating an example of steps carried out by a processing device to process a media file comprising corrupted timed media content data according to some embodiments of the invention; and

FIG. 16 schematically illustrates a processing device configured to implement at least one embodiment of the present invention.

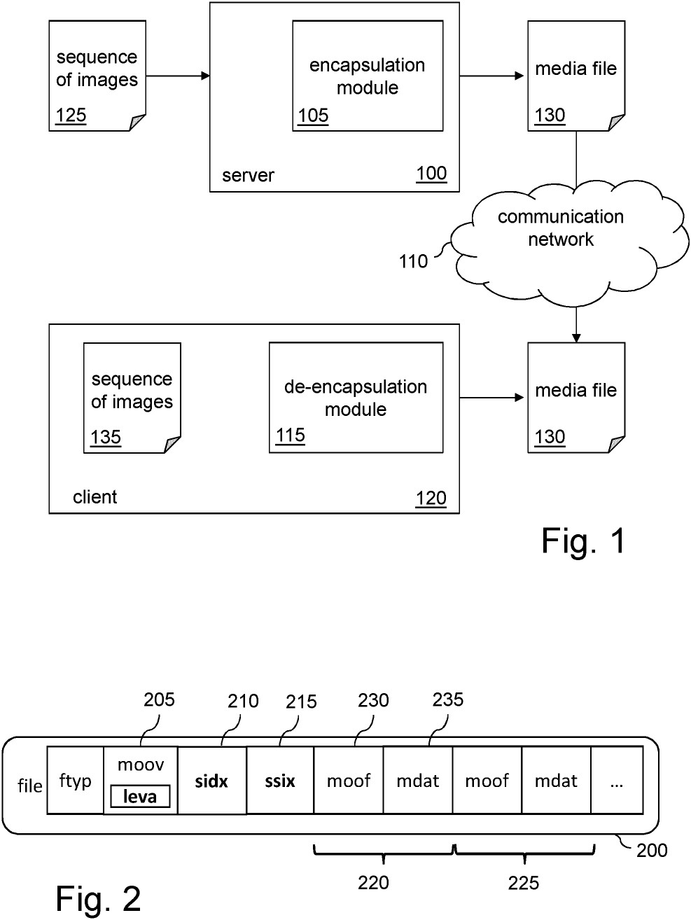

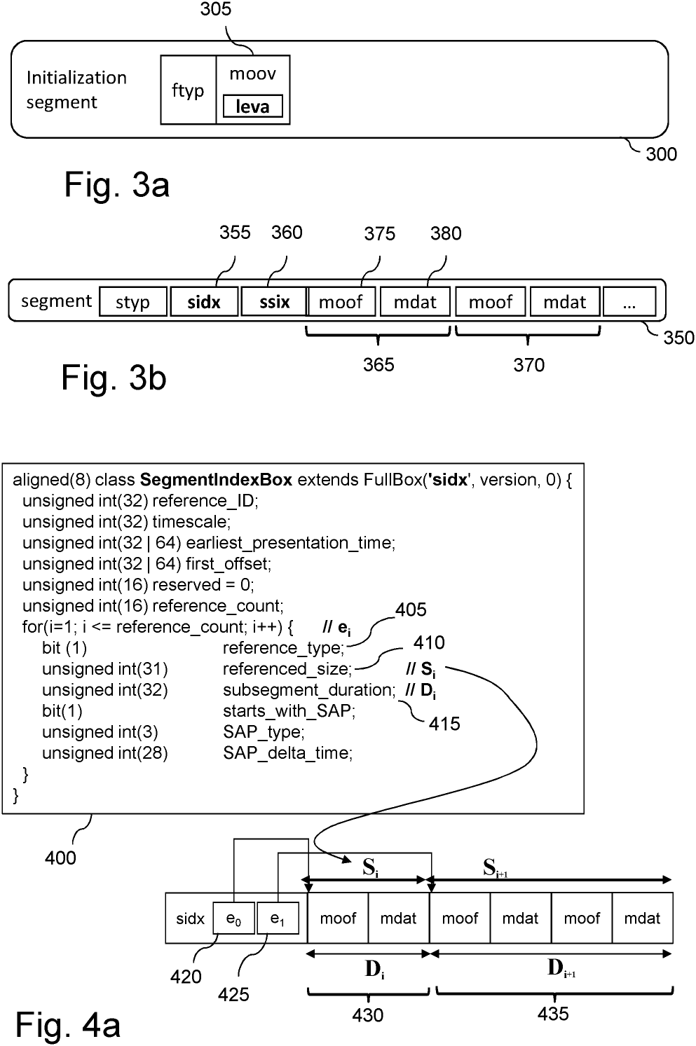

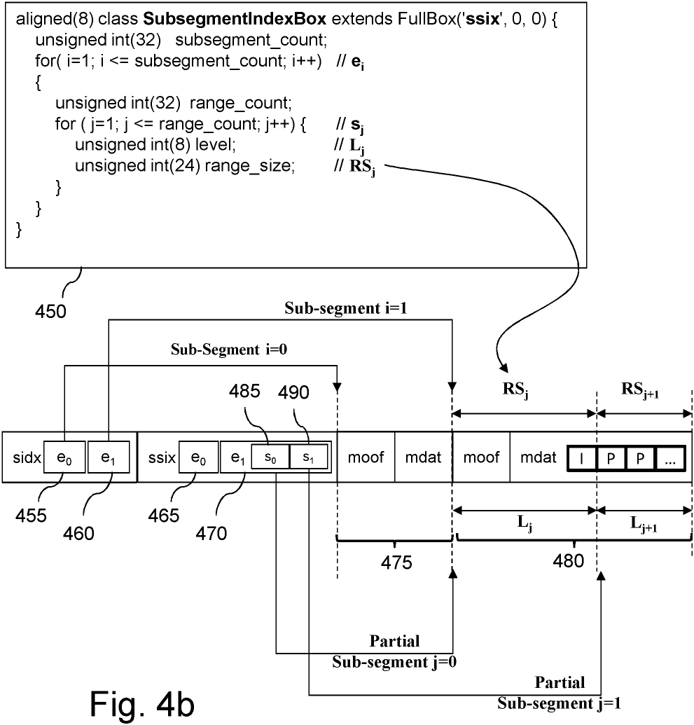

### DETAILED DESCRIPTION OF THE INVENTION

According to some embodiments, the invention makes it possible to reduce the complexity of description of the indexation of multiple byte ranges for a same level, for instance to signal multiple Stream Access Points (SAP) within a sub-segment. The invention also makes it possible to introduce new level values or to change the feature associated with a level on the fly.

This is obtained by providing means to set predefined feature types (also denoted predefined level assignment types) and to use a segment index box ‘sidx’ and a sub-segment index box ‘ssix’ without requiring the definition of a level assignment box ‘leva’ and possibly their associated sample groups.

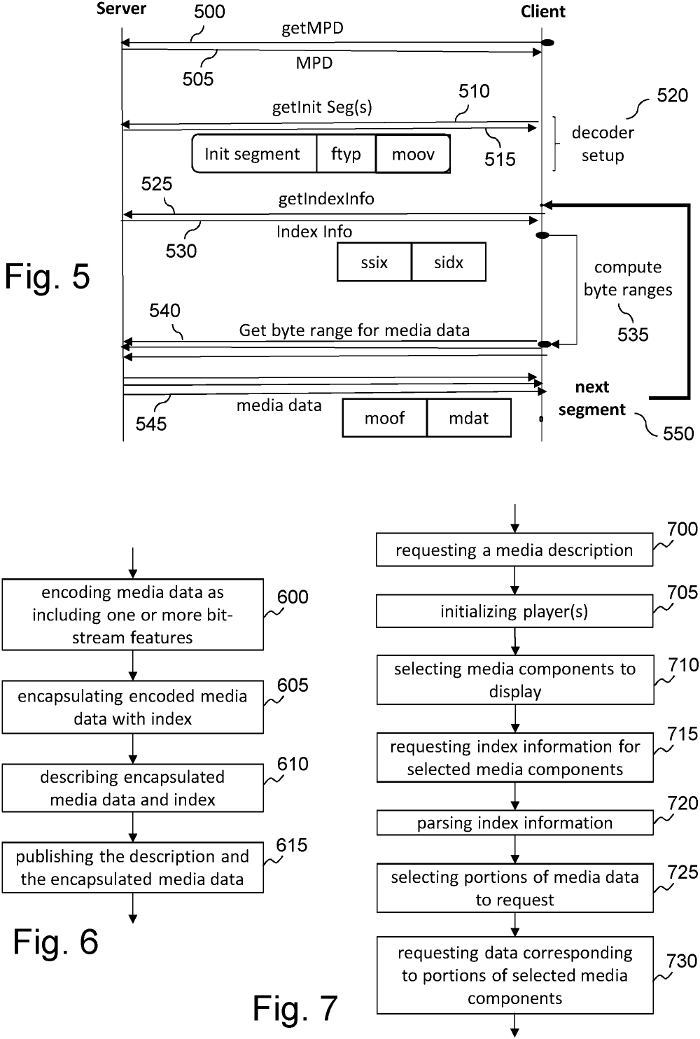

FIG. 5 illustrates requests and responses between a server and a client, as performed with DASH according to some embodiments, to obtain media data. For the sake of illustration, it is assumed that the data are encapsulated in ISOBMFF and a description of the media components is available in a DASH Media Presentation Description (MPD).

As illustrated, a first request and response (steps 500 and 505) aim at providing the streaming manifest to the client, that is to say the media presentation description. From the manifest, the client can determine the initialization segments that are required to set up and initialize its decoder(s). Next, the client requests one or more of the initialization segments identified according to the selected media components through HTTP requests (step 510). The server replies with metadata (step 515), typically the ones available in the ISOBMFF ‘moov’ box and its sub-boxes. The client does the set-up (step 520) and may request index information from the server (step 525). This is the case for example in DASH profiles where indexed media segments are in use, e.g. live profile. To achieve this, the client may rely on an indication in the MPD (e.g. indexRange) providing the byte range for the index information. When the media data are encapsulated according to ISOBMFF, the segment index information may correspond to the Segmentlndex box ‘sidx’ and optionally an associated new version of the sub-segment index box ‘ssix’ according to some embodiments of the invention, as described here after. In the case according to which the media data are encapsulated according to MPEG-2 TS, the indication in the MPD may be a specific URL referencing an Index Segment.

Next, the client receives the requested segment index from the server (step 530). From this index, the client may compute byte ranges (step 535) to request movie fragments or portions of a movie fragment at a given time (e.g. corresponding to a given time range) or corresponding to a given feature of the bit-stream (e.g. a point to which the client can seek (e.g. a random-access point or stream access point), a scalability layer, a temporal sub-layer or a spatial sub-part such as a HEVC tile or VVC subpicture. The client may issue one or more requests to get one or more movie fragments or portions of movie fragments (typically portions of data within the Media data box) for the selected media components in the MPD (step 540). The server replies to the requested data by sending one or more sets of data byte ranges comprising ‘moof’, ‘mdat’ boxes, or portions of ‘mdat’ boxes (step 545). It is observed that the requests for the movie fragments may be made directly without requesting the index, for example when media segments are described as segment template and no index information is available.

Upon reception of the requested data, the client decodes and renders the corresponding media data and prepares the request for the next time interval (step 550). This may consist in getting a new index, even sometimes in getting an MPD update or simply to request next media segments as indicated in the MPD (e.g. following a SegmentList or a SegmentTemplate description).

FIG. 6 is a block diagram illustrating an example of steps carried out by a server or file writer to encapsulate and transmit data to a client according to some embodiments of the invention.

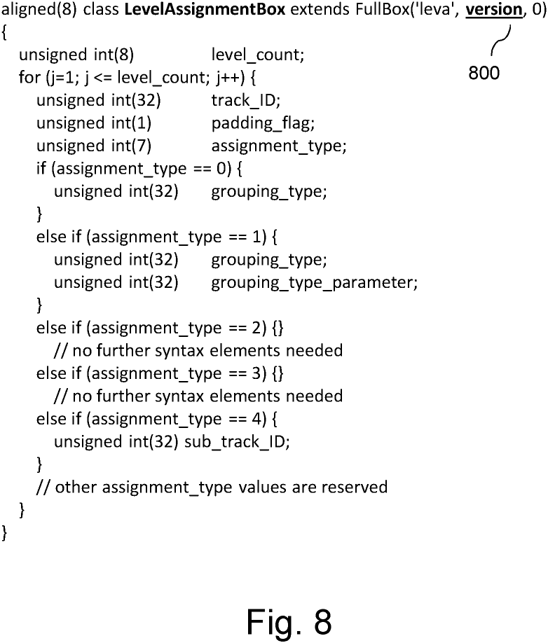

As illustrated, a first step is directed to encoding media content data as including one or more bit-stream features (e.g. points to which the client can seek (i.e. random-access points or stream access points), scalability layers, temporal sub-layers, and/or spatial sub-parts such as HEVC tiles or VVC sub-pictures) (step 600). Potentially, multiple alternatives of the encoded media content can be generated, for example in terms of quality, resolution, etc. The encoding step results in bit-streams that are encapsulated (step 605). The encapsulation step comprises generating structured boxes containing metadata describing the placement and timing of the media content data. The encapsulation step (605) may also comprise generating indexes to make it possible to access sub-parts of the encoded media content, for example as described by reference to FIGS. 8, 9, 10, 11a, 11b, 11c, 12a, 12b, and 12c, (e.g. by using a ‘sidx’, a modified ‘ssix’, and optionally a modified ‘leva’).

Next, one or more media files or media segments resulting from the encapsulation step are described in a streaming manifest (step 610), for example in a MPD. Next, the media files or segments with their description are published on a streaming server for diffusion to clients (step 615).

A file writer may only conduct steps 600 and 605 to produce encapsulated media data and save them on a storage device.

FIG. 7 is a block diagram illustrating an example of steps carried out by a client to obtain data from a server according to some embodiments of the invention.

As illustrated, a first step is directed to requesting and obtaining a media presentation description (step 700). Next, the client gets initialization information (e.g. the initialization segments) from the server and initializes its player(s) and/or decoder(s) (step 705) by using items of information of the obtained media description and initialization segments.

Next, the client selects one or more media components to play from the media description (step 710) and requests information on these media components, for example index information (step 715) including for instance a ‘sidx’ box, a ‘ssix’ box modified according to some embodiments of the invention, and optionally a ‘leva’ box modified according to some embodiments of the invention. Next, after having parsed received index information (step 720), the client may determine byte ranges for data to request, corresponding to portions of the selected media components (step 725). Next, the client issues requests for the data that are actually needed (step 730).

As described by reference to FIG. 5, this may be done in one or more requests and responses between the client and a server, depending on the index used during the encapsulation and the level of description in the media presentation description.

A file parser may only conduct steps 705 to 725 to access portions of data from an encapsulated media content data located on a local storage device.

According to an aspect of some embodiments of the invention, a new version of the level Issignment box ‘leva’ is defined to authorize multiple byte ranges for a given level.

FIG. 8 illustrates an example of the syntax of a new version of the level assignment box according to some embodiments of the invention. According to this example, the following parameters and values are used:
level_count: this parameter specifies the number of levels each fraction (e.g. each sub-segment indexed within a sub-segment index box ‘ssix’) is grouped into. The value of level_count parameter is greater than or equal to two;
track_ID for loop entry j: this parameter specifies the track identifier of the track assigned to level j;
padding_flag:
   when this parameter is equal to one, it indicates that a conforming fraction can be formed by concatenating any positive integer number of levels within a fraction and padding the last MediaDataBox by zero bytes up to the full size that is indicated in the header of the last MediaDataBox;
   when this parameter is equal to zero, this is not assured;
assignment_type: this parameter indicates the assignment mechanism to be used for assigning a specific feature meaning to a given level value. According to some embodiments, assignment_type values greater than four are reserved, while the semantics for the other values are specified as follows. Still according to some embodiments, the sequence of assignment_types is restricted to be a set of zero or more of type two or three, followed by zero or more of exactly one type
   0: sample groups are used to specify levels, i.e., samples mapped to different sample group description indexes of a particular sample grouping lie in different levels within the identified track; other tracks are not affected and have all their data associated with one level;
   1: sample groups are used to specify levels, as it is the case when the assignment_type is set to zero, except the level assignment depends on a parameterized sample group;
   2, 3 : the level assignment mechanism is based on tracks;
   4: the respective level contains the samples for a sub-track. The sub-tracks are specified through the SubTrackBox; other tracks are not affected and have all their data in precisely one level;
grouping_type and grouping_type_parameter, if present, these parameters specify the sample grouping used to map sample group description entries in the SampleGroupDescriptionBox to levels. Level n contains the samples that are mapped to the SampleGroupDescriptionEntry having index n in the SampleGroupDescriptionBox having the same values of grouping_type and grouping_type_parameter, if present, as those provided in this box;
sub_track_ID specifies that the sub-track identified by sub_track_ID within loop entry j is mapped into level j.

According to the example illustrated in FIG. 8, the semantic of the level assignment box depends on the value of the version parameter 800.

When version 0 of the level assignment box ‘leva’ is used, within a fraction, data for each level appear contiguously, and data for levels appear in increasing order of level values. All data in a fraction are assigned to levels. When new version 1 or more of the level assignment box ‘leva’ is used, data for each level need not be stored contiguously and data for levels may be stored in random order of level value. Some data in a fraction may have no level assigned, in which case the level is unknow but is not a level from the levels defined by the level assignment box.

According to particular embodiments, a new version of the sub-segment index box ‘ssix’ is defined to authorize either multiple byte ranges for a given level with the level assignment provided by a ‘leva’ box or to authorize a single or multiple byte ranges for a given level, through predefined feature types (also denoted level assignment types), without defining a ‘leva’ box.

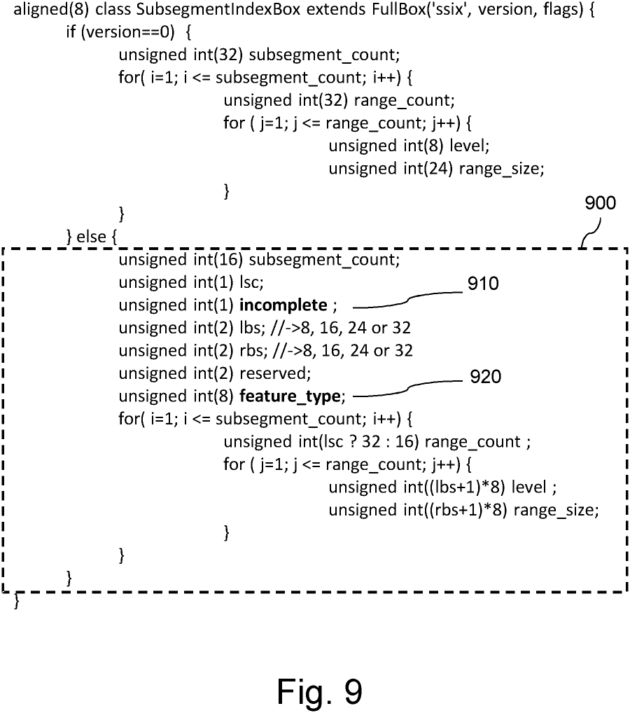

FIG. 9 illustrates an example of the syntax of a new version of the sub-segment index box ‘ssix’, referenced 900.

According to this new version, the sub-segment index box ‘ssix’ provides a mapping of levels to byte ranges of the indexed sub-segment, as specified by a level assignment box ‘leva’, (located in the movie box ‘moov’) or as indicated in the ‘ssix’ box itself. The indexed sub-segments are described by a segment index box ‘sidx’. In other words, this ‘ssix’ box provides a compact index describing how the data in a sub-segment are ordered in partial sub-segments, according to levels. It enables a client to easily access data for partial sub-segments by downloading ranges of data in the sub-segment.

According to some embodiments, there is none or one sub-segment index boxes ‘ssix’ per segment index box ‘sidx’ that indexes only leaf sub-segments, i.e. that indexes only sub-segments (but no segment indexes). A sub-segment index box ‘ssix’, if any, is the next box after the associated segment index box ‘sidx’. A sub-segment index box ‘ssix’ documents the sub-segments that are indicated in the immediately preceding segment index box ‘sidx’.

It is observed here that, in general, the media data constructed from the byte ranges are incomplete, i.e. they do not conform to the media format of the entire sub-segment.

According to some embodiments and for version 0 of the ‘ssix’ box, each level is assigned to exactly one partial sub-segment according to an increasing order of level values, i.e. byte ranges associated with one level are contiguous and samples of a partial sub-segment may depend on any sample of preceding partial sub-segments in the same sub-segment (but cannot depend on samples of following partial sub-segments in the same sub-segment). This implies that all data for a given level require a single byte range to be retrieved.

According to some embodiments of the invention, for the new version 1 or higher of the ‘ssix’ box, multiple byte ranges, possibly discontinuous, associated with the same level, may be described. As a consequence, obtaining all the data corresponding to a given level may require multiple byte ranges to be retrieved.

It is noted that when a partial sub-segment is accessed in this way, for any assignment_type value other than three in the level assignment box ‘leva’, the final media data box may be incomplete, that is, less data than indicated by the length indication of the media data box are present. Therefore, the length stored within the media data box may need to be adjusted or padding may be needed.

It is also noted that the byte ranges corresponding to partial sub-segments may include both movie fragment boxes and media data boxes. The first partial sub-segment, i.e. the partial sub-segment associated with the lowest level, corresponds to a movie fragment box as well as (parts of) media data box(es), whereas subsequent partial sub-segments (partial sub-segments associated with higher levels) may correspond to (parts of) media data box(es) only.

According to particular embodiments of the invention and for version 0 of the sub-segment index box ‘ssix’, the presence of the level assignment box ‘leva’ in the movie box ‘moov’ is required and the level assignment box ‘leva’ have a version equal to 0.

Still according to particular embodiments of the invention and for version 1 or higher of the sub-segment index box ‘ssix’, the presence of the level assignment box ‘leva’ is only required for a feature type (or level_assignment_type) equals to 0, in which case the level assignment box ‘leva’ have a version set tof 1. The presence of the level assignment box ‘leva’ is not required for the other feature type values.

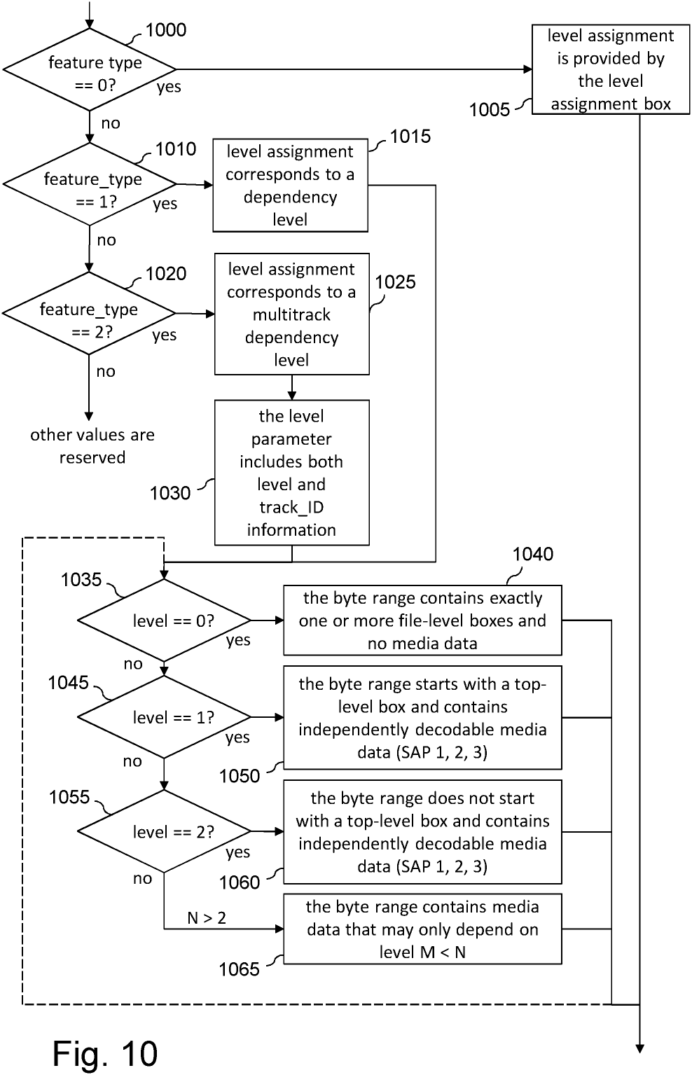

Still according to particular embodiments of the invention, the semantics of the attributes in the new version of the ‘ssix’ may be defined as follows:
subsegment_count parameter is a parameter having a positive integer value specifying the number of sub-segments for which partial sub-segment information is specified in this box. The subsegment_count parameter value is equal to the reference_count parameter value (i.e., the number of movie fragment references) in the immediately preceding segment index box ‘sidx’;
lsc is a flag that indicates, when it is set (e.g. when its value is equal to one), that the number of indexed ranges within a partial sub-segment is coded onto 32 bits, otherwise the number of indexed ranges within a partial sub-segment is coded onto 16 bits;
incomplete is a new flag, referenced 910 in FIG. 9, that indicates, when it is set (e.g. when its value is equal to one), that the last range of a given sub-segment may not cover the entire sub-segment, in which case assignment of remaining bytes to a level is unknown but the remaining bytes do not correspond to any level listed in the box. This flag allows warning the reader that one or more sub-segments are not completely indexed and to define a last byte ranges assigned to an unknown level value; in other words, the incomplete flag is an indication that the sum of byte ranges in a sub-segment may not be equal to the corresponding sub-segment size indicated in ‘sidx’ box;
lbs is a parameter that gives the number of bytes, minus 1, that are used for coding the level field;
rbs is a parameter that gives the number of bytes, minus 1, that are used for coding the range field;
feature_type (also denoted level_assignment_type) is a new parameter, referenced 920 in FIG. 9, that gives the associated predefined semantics of the indicated level. For the sake of illustration, it may be defined as follows:
   0: if the feature_type parameter is set to zero, the level value assigned to a partial sub-segment corresponds to the level indicated in the ‘leva’ box. As described above, the ‘leva’ box indicates the mechanism used to specify the assignment of a feature to this level value. If the partial sub-segment (byte range) is not associated with any information in the level assignment, then any level that is not included in the level assignment may be used. This value should only be used when the leva box version is 1 or more;
   1: if the feature_type parameter is set to one, the level value may correspond to a dependency level, for example as described in reference to FIG. 10;
      2: if the feature_type parameter is set to two, the level value corresponds to a multitrack dependency level. In this mode, lbs is equal to one or more (i.e., at least 16 bits to code the level). The first 8 bits of the level field give the dependency level value, with the same values and semantics as the ones set for the level_assignment_type value two. The remaining less significant bits of the level field give a track_ID, which identifies a track of the movie present in the indexed sub-segment for level values other than zero. It is set to zero if the level value is equal to zero. In this mode, each range consists only of data from the identified track, possibly with some meta-data boxes (e.g. movie fragments, etc.). The level value only gives dependency information within the track. This allows cross-track indexation within a same level;
      3, 4, 5, 6, 7 are reserved values;
range count is a parameter that specifies the number of partial sub-segment levels into which the media data are grouped. In the case where the version of the ‘ssix’ box is 0, this value is greater than or equal to two and each byte in the sub-segment is explicitly assigned to a level. In the case where the version of the ‘ssix’ box is 1 or more, this value may be 0 or more, and the described ranges may lead to a size smaller than the one of the sub-segment if and only if incomplete flag is set to one. It is noted that the value of the range_count parameter could be restricted to one or more instead of zero or more;
range_size is a parameter that indicates the size of the partial sub-segment. The value zero may be used in the last entry to indicate the remaining bytes of the segment, to the end of the segment.
level is a parameter that specifies the level to which the considered partial sub-segment is assigned.

Alternatively, the flags Isc, lbs, and rbs can be removed from the box syntax and defined as parts of the FullBox flags instead.

In a variant, the incomplete flag is optional or could be removed since this information can be deduced by cross-checking the sum of byte ranges of a sub-segment with the sub-segment size documented in the ‘sidx’ box.

In a variant, different values of incomplete flag or feature type can be signalled for each sub-segment within a segment by declaring them within the subsegment_count loop in the new version of ‘ssix’ box.

Still alternatively, it is possible to define more than one sub-segment index box ‘ssix’ with version 1 or higher per segment index box ‘sidx’ that indexes only leaf sub-segments. In such cases, the multiple sub-segment index boxes ‘ssix’ all document the sub-segments that are indicated in the immediately preceding segment index box ‘sidx’ and each sub-segment index box uses a different predefined feature type, referenced 920 in FIG. 9. This allows defining byte ranges for different features per sub-segment. For example, a sub-segment index box ‘ssix’ can be used to document the stream access points, and another sub-segment index box ‘ssix’ can be used to document the corrupted byte ranges.

According to another aspect of the invention, the data of a sample or a NALU (Network Abstraction Layer (NAL) unit) within a sample that are actually corrupted or lost are signalled. Data corruption may happen, for example, when data are received through an error-prone communication mean. To signal corrupted data in the bit-stream to be encapsulated, a new sample group description with grouping_type ‘corr’ may be defined. This sample group ‘corr’ can be defined in any kind of tracks (e.g. video, audio or metadata). For the sake of illustration, an entry of this sample group description may be defined as follows:

class CorruptedSampleInfoEntry()
extends SampleGroupDescriptionEntry (‘corr’)
{
bit(2) corrupted;
bit(6) reserved;
}

where corrupted is a parameter that indicates the corruption state of the associated data.

According to some embodiments, value 1 means that the entire set of data is lost. In such a case, the associated data size (sample size, or NAL size) should be set to 0. Value 2 means that the data are corrupted in such a way that they cannot be recovered by a resilient decoder (for example, loss of a slice header of a NAL). Value 3 means that the data are corrupted, but that they may still be processed by an error-resilient decoder. Value 0 is reserved.

According to some embodiments, no associated grouping_type_parameter is defined for CorruptedSamplelnfoEntry. If some data are not associated with an entry in CorruptedSamplelnfoEntry, this means these data are not corrupted and not lost.

A SampleToGroup Box ‘sbgp’ with grouping_type equal to ‘corr’ allows associating a CorruptedSamplelnfoEntry with each sample and indicating if the sample contains corrupted or lost data.

This sample group description with grouping_type ‘corr’ can be also advantageously combined within the NALU mapping mechanism composed by a sampletogroup box ‘sbgp’, a sample group description box ‘sgpd’, both with grouping_type ‘nalm’ and sample group description entries NALUMapEntry. A NALU mapping mechanism with a grouping_type_parameter set to ‘corr’ allows signalling corrupted NALUs in a sample. The groupID of the NALUMapEntry map entry indicates the index, beginning from one, in the sample group description of the CorruptedSamplelnfoEntry. A grouplD set to zero indicates that no entry is associated herewith (the identified data are present and not corrupted).

This sample group ‘corr’ with or without NALU mapping may be used in a media file even if no indexing is performed.

This sample group ‘corr’ with or without NALU mapping may also be used in a track with a sample entry of type ‘icpv’ (signalling an incomplete track) to provide more information on which samples or NALUs in a sample (when combined with NALU mapping) are corrupted or missing.

In an alternative, when the sample group ‘corr’ is combined with the NALU mapping, it may be defined as a virtual sample group, i.e, no sample group description box ‘sgpd’ is defined with grouping_type ‘corr’ and entries CorruptedSampleInfoEntry. Instead, when a SampleToGroupBox of grouping_type ‘nalm’ contains a grouping_type_parameter equal to the virtual sample group ‘corr’, the most-significant 2-bits of the grouplD in NALUMapEntry in the SampleGroupDescriptionBox with grouping_type ‘nalm’ directly provides the corrupted parameter value (as described above) associated with the NAL unit(s) mapped to this grouplD.

In an alternative embodiment, the sample group ‘corr’ can be extended to signal codec-specific information describing the type of corruptions or losses in data of a sample. This item of information can be specified for each derived ISOBMFF specification (e.g. storage of NAL unit structured video in ISOBMFF ISO/IEC 14496-15, Omnidirectional MediA Format (OMAF) ISO/IEC 23090-2, Carriage of Visual Volumetric Video-based Coding (V3C) Data ISO/IEC 23090-10) or for each video codec, audio codec, or metadata specification (e.g. AVC, MVC, HEVC, VVC, AV1, VP9, AAC, MP3, MPEG-H 3D audio, XMP...). Each specification can define what should be indicated for such corrupted data in a sample.

For the sake of illustration and according to this alternative embodiment, an entry of a sample group description with grouping type ‘corr’ may be defined as follows,

class CorruptedSampleInfoEntry()
extends SampleGroupDescriptionEntry (‘corr’)
{
bit (2) corrupted;
bit (6) reserved;
if (corrupted==2)
bit (32) codec_specific_param; }

where
the corrupted parameter indicates the corruption state of the associated data. Still for the sake of illustration, the value of the corrupted parameter may be defined as follows:
   value 0 means that the entire data is lost, and the associated data size (sample size, or NAL size) is 0,
   value 1 means that the data is corrupted without any additional information on the corruption,
   value 2 means that the data is corrupted with codec specific information on the corruption, and
   value 3 is reserved.
the codec_specific_param parameter provides codec specific information directed to the corruption. The meaning of the codec_specific_param parameter actually depends on the coding format associated with the sample associated with the CorruptedSampleInfoEntry ( ) entry. The coding format is the one of the associated samples. It is noted that the meaning of the codec_specific_param parameter being dependent on the coding format, file writers may need to add and associate a different CorruptedSampleInfoEntry ( ) entry with a sample each time the coding format is changing across samples.

If no data are associated with a CorruptedSampleInfoEntry entry by a sample group with the grouping_type ‘corr’, or if data are associated with a description_group_index = 0 by a sample group with the grouping_type ‘corr’, this means that the data are not corrupted.

The processing of a sample with the corrupted parameter equal to 1 or 2 is context and implementation specific.

As an example, for NALU-based video formats (e.g. AVC, SVC, MVC, HEVC, VVC, EVC whose storage in ISOBMFF is specified in ISO/IEC 14496-15), the codec_specific_param parameter of the CorruptedSampleInfoEntry entry can be defined as a bit mask, with most significant bit first, of the following flags:
ParameterSetCorruptedFlag (value 0×00000001): indicates that one or more parameter sets (DCI, VPS, SPS, PPS, APS, OPI) in the associated data are corrupted,
SEICorruptedFlag (value 0×00000002): indicates that one or more SEI messages in the associated data are corrupted,
SliceHeaderCorruptedFlag (value 0×00000004): indicates that one or more slice headers or picture headers in the associated data are corrupted,
VCLCorruptedFlag (value 0×00000008): indicates that VCL data of one or more slices in the associated data are corrupted, and
OtherNonVCLNALCorruptedFlag (value 0×00000010): indicates that one or more NAL units in the associated data with types different from the above types are corrupted. Examples of such other non-VCL NAL units are AUD, EOB, and EOS NAL units.

As another example, it is also possible to define codec specific corruption signalling that remains generic for several codecs, the codec_specific_param parameter of the CorruptedSampleInfoEntry entry can be defined as a bit mask, with most significant bit first, of the following flags:
MandatoryHeaderCorruptedFlag (value 0×00000001) indicates that one or more timed media content data units representing mandatory header information in the associated data are corrupted,
DiscardableHeaderCorruptedFlag (value 0×00000002) indicates that one or more timed media content data units representing discardable header information in the associated data are corrupted,
CodedDataCorruptedFlag (value 0×00000004) indicates that one or more timed media content data units representing compressed data in the associated data are corrupted,
MetadataCorruptedFlag (value 0×00000004) indicates that one or more timed media content data units representing descriptive metadata in the associated data are corrupted, and
OtherCorruptedFlag (value 0×00000010) indicates that one or more timed media content data units with type different from the above types are corrupted. Examples of such other non-coded units are delimiter or padding units.

A codec_specific_param parameter with value 0 means that no information is available for describing the corruption.

A CorruptedSampleInfoEntry entry may be used with a sample group of the grouping_type ‘nalm’ and a NALUMapEntry, using the grouping_type_parameter ‘corr’. The grouplD of the NALUMapEntry map entry indicates the index, starting from 1, in the sample group description of the grouping_type ‘corr’ of the CorruptedSampleInfoEntry entry. A grouplD of 0 indicates that no entry is associated (the data identified by the sample group of grouping_type ‘nalm’ is present and not corrupted).

More generally, a CorruptedSampleInfoEntry entry may be used with any sample group providing a functionality similar to the sample group of the grouping_type ‘nalm’, i.e. that allows associating properties with sub-units of a sample, e.g. NAL units, subpictures, tiles, slices, or Open Bitstream Units.

In a variant, the ParameterSetCorruptedFlag flag may be split per NAL type, i.e. different values of the codec_specific_param bit-mask may be defined for each type of parameter set NAL units to signal if this specific type of parameter set NAL units is corrupted (e.g. the bit-masks DCICorruptedFlag, VPSCorruptedFlag, SPSCorruptedFlag, SPSCorruptedFlag, PPSCorruptedFlag, APSCorruptedFlag, OPICorruptedFlag, etc.).

In another variant, a specific value of the bit-mask codec_specific_param can be defined to signal that Picture Header NAL units are corrupted.

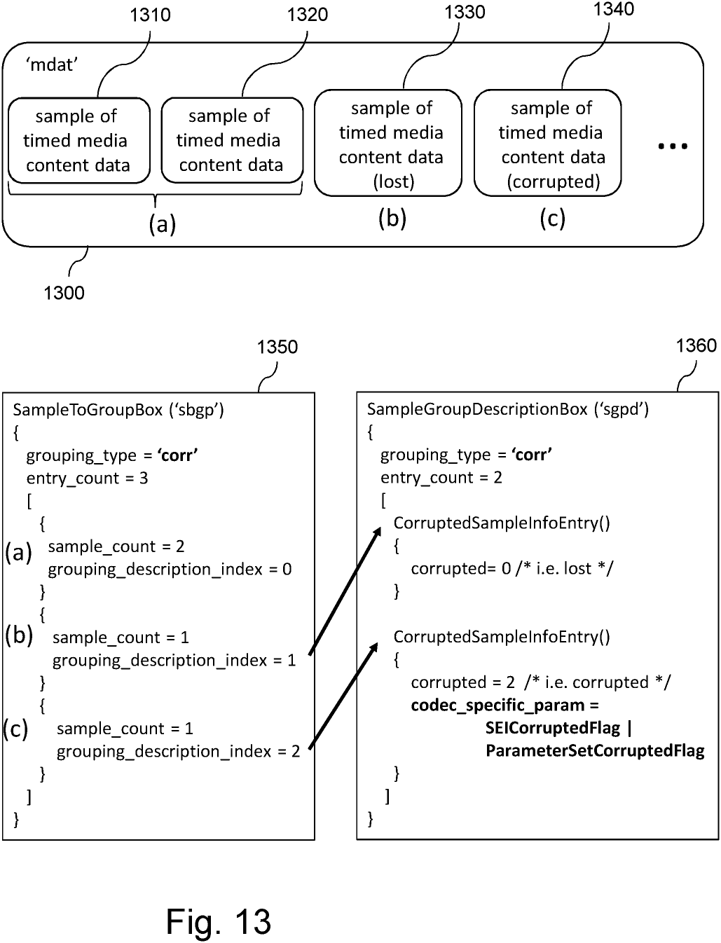

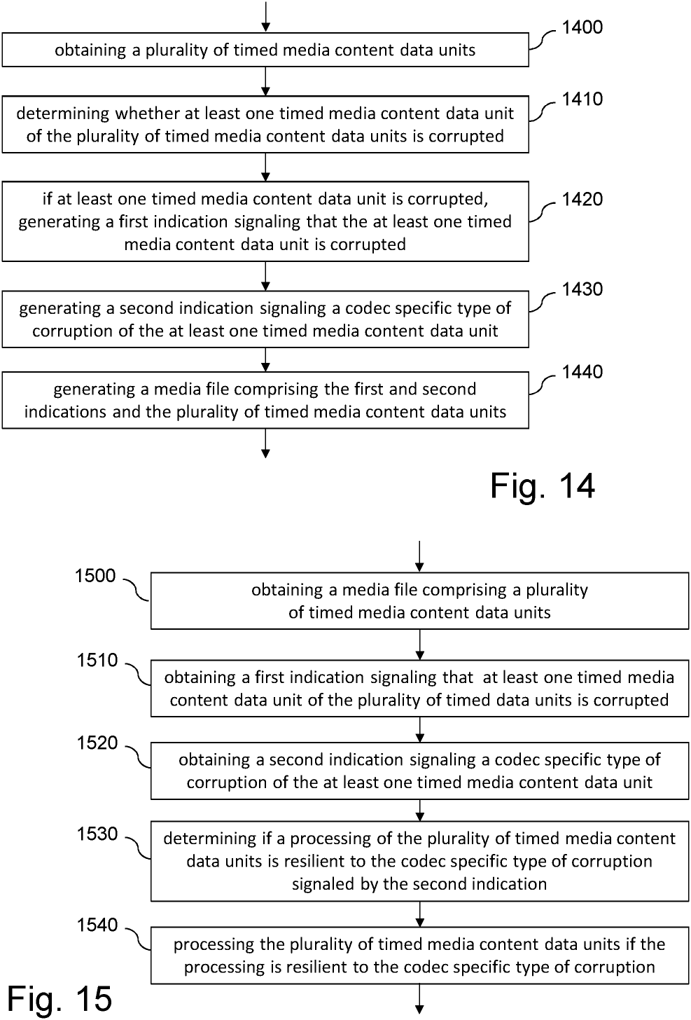

In the following, FIG. 13 illustrates an example of signalling corrupted timed media content data according to the above alternative embodiment. FIGS. 14 and 15 respectively illustrate an example of steps of generating a media file comprising corrupted timed media content data and an example of steps of processing a media file comprising corrupted timed media content data according to the above alternative embodiment.

This sample group description or alternatives with grouping_type ‘corr’ can also be used to signal corrupted data within a partial sub-segment and its corresponding byte range defined by a sub-segment index box ‘ssix’. A level value can be assigned to a CorruptedSamplelnfoEntry through a level assignment box by setting the assignment type to zero (i.e. using sample groups) and the grouping type to ‘corr’

As another alternative, rather than relying on the level assignment box ‘leva’, a new value of predefined feature type can be defined in the version 1 of sub-segment index box ‘ssix’. For the sake of illustration, such a predefined feature type may correspond to the value three, signalling that each level value corresponds to a data integrity level, and may be defined as follows:
level 0 indicates that the byte range is not corrupted;
level 1 indicates that the entire set of data is lost (the associated range size is 0);
level 2 indicates that the byte range is corrupted in such a way that the corresponding data cannot be recovered by a resilient decoder (for example, loss of a slice header of a NAL);
level 3 indicates that the byte range is corrupted, but the corresponding data may still be processed by an error-resilient decoder; and
other level values are reserved.

Accordingly, it is possible to signal whether a partial sub-segment is corrupted or not without going through a level assignment box and without defining a sample group of grouping_type ‘corr’

In a variant, when the level indicates that the byte range is corrupted, an additional codec_specific_param parameter may also be defined with the same semantics as described above to indicate codec specific information on the corruption of the byte range.

Still according to another aspect of the invention, the parameter set NAL units (e.g. Video Parameter Set (VPS), Sequence Parameter Set (SPS), Picture Parameter Set (PPS), etc.) are indexed in the encapsulated bit-stream. To ease their indexing and to avoid multiplying the number of byte ranges (e.g. to avoid having one byte range per NAL unit), they can be grouped together in a continuous byte range. This can be done by defining an array of NAL units in the decoder config record in sample entries but in such a case, the sample entries are all defined in the initial movie box ‘moov’ and cannot be updated on the fly. However, when the bit-stream is fragmented and encapsulated into multiple media segments, it may be useful to be able to update the array of parameter set NAL units per fragment.

According to some embodiments of the invention, it is allowed to declare the sample description box, not only in the movie box ‘moov’, but also in the movie fragment box ‘moof’. It is then possible to declare new sample entries with an updated array of parameter set NAL units at movie fragment level. Samples are associated with a sample entry via a sample description index value. The range of values for the sample description index is split into two ranges to allow distinguishing sample entries defined in the movie box ‘moov’ from sample entries defined in a movie fragment box ‘moof’, for example as follows:
values from 0×0001 to 0×10000: these values may be used to signal a sample description index to a sample entry located in the sample description box ‘stsd’ for the current track in the movie box; and
values 0×10001 -> 0×FFFFFFFF: hese values, minus 0×10000, may be used to signal a sample description index to a sample entry located in the sample description box ‘stsd’ for the current track in the movie fragment box ‘moof’.

The sample entries given in a sample description box ‘stsd’ defined in a movie fragment are only valid for the corresponding media fragment.

The updated parameter set NAL units defined in a movie fragment can be easily retrieved by using a sub-segment index box with version 1, a feature type equal to 1, and a level 0 to index the movie fragment containing the array of parameter set NAL units.

The ability to define new sample entries in a movie fragment box ‘moof’ in addition to the movie box ‘moov’ (denoted as dynamic sample entries) may be used in a media file even if no indexing is performed in order to provide updates of parameter sets without mixing corresponding non-VCL NALUs with VCL NAL units for the samples.

Having dynamic sample entries provides an alternative to in-band signalling of parameter sets or to the use of dedicated parameter set track. This could be useful, for example in VVC coding format for Adaptation Parameter Set (APS) NALUs that may be much more dynamic than other Parameter Set NALUs (e.g. Sequence Parameter Set (SPS), Picture Parameter Set (PPS) NALUs).

In an alternative, new sample entry types may be reserved to indicate that tracks with those sample entry types contain dynamic sample entries.

In a variant use case, the ability to declare new sample entries in a media fragment provides for instance a mean to update along time the table of metadata keys (located in a Metadata Key Table Box declared in sample entry of type ‘mebx’) in a multiplexed timed metadata track.

FIG. 10 illustrates an example of steps carried out by a client to interpret levels assigned to byte ranges in a sub-segment using the new version of the sub-segment index box.

As illustrated, a first step is directed to determining whether the feature type is equal to zero (step 1000). If the feature type is equal to zero, the level attribute is interpreted according to the level assignment defined by the level assignment box ‘leva’ as defined in ISO/IEC 14496-12 (step 1005).

On the contrary, if the feature type is not equal to zero, a second test is carried out to determine whether the feature type is equal to one (step 1010). If the feature type is equal to one, the level attribute is interpreted as a dependency level (step 1015).

If the feature type is not equal to one, a third test is carried out to determine whether the feature type is equal to two (step 1020). If the feature type is equal to two, the level attribute is interpreted as a multitrack dependency level (step 1025). In such a case, the level attribute is composed of two items of information, a level (also denoted dependency level) as defined for the feature type equal to one and an identifier of the track to which the data of the byte range belong (step 1030).

Next, if the level attribute is interpreted as a dependency level or as a multitrack dependency level, the definition of the dependency level is obtained.

As illustrated, if a level value is equal to zero (reference 1035), this means that the associated byte range contains exactly one or more file-level boxes (e.g. movie fragment, reference 1040). Media data boxes are not included in level 0 byte ranges.

If a level value is equal to one (reference 1045), this means that the associated data are independently decodable (SAP 1, 2 or 3, reference 1050). Byte ranges assigned to level 1 may contain the initial part of the sub-segment (e.g. movie fragment box). The beginning of a byte range assigned to level 1 coincides with the beginning of a top-level box in the sub-segment.

If the level value is equal to two (reference 1055), this means that the associated data are independently decodable (SAP 1, 2 or 3, reference 1060)). The beginning of a byte range assigned to level 2 does not coincide with the beginning of a top-level box in the sub-segment.

If the level value is equal to N (step 1055), N being greater than two, this means that the associated data require data from the preceding byte ranges with lower levels (level N-1 and below) to be processed (step 1065), stopping at the last specified level 0 byte range if specified, otherwise at the last specified level 1 or 2 byte range if specified, otherwise at the first byte range. Byte ranges assigned to levels other than 2 may contain movie fragment box.

As suggested with a dashed line arrow, the meaning of the level value is estimated for each byte-range.

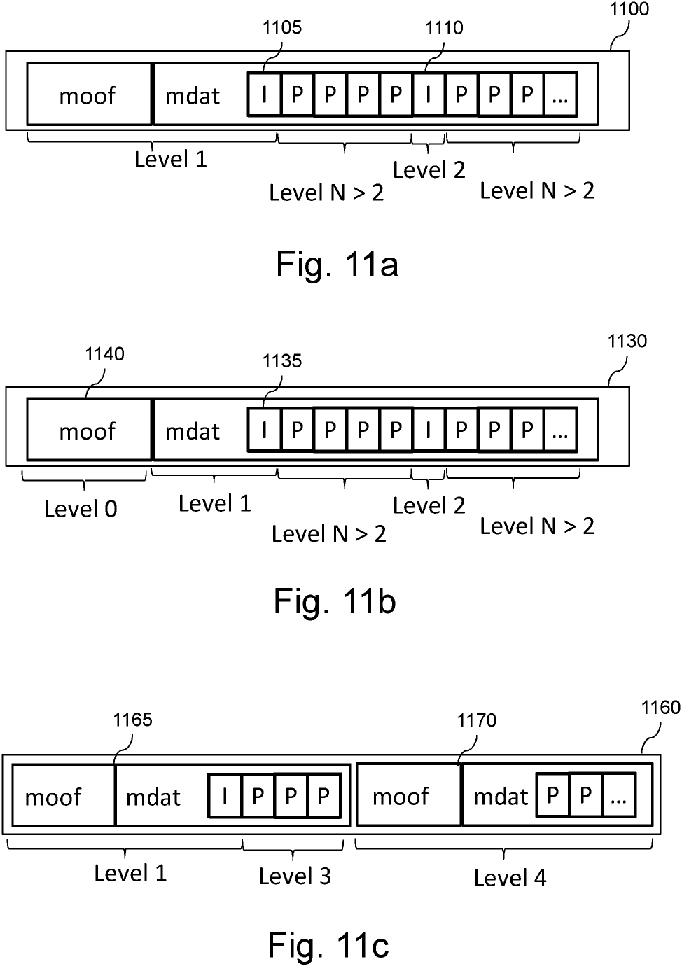

FIG. 11a illustrates a first example of level assignment using the new version of the sub-segment index box ‘ssix’.

According to this example, the level assignment is used to identify the byte ranges corresponding to the stream access points referenced 1105 and 1110 (e.g. instantaneous decoding refresh (IDR) frames) in the sub-segment referenced 1100. The feature type is set to the predefined value 1 (identifying dependency levels). In this example, there is no explicit range for the movie fragment box ‘moof’. The first byte range begins with a file-level box, the movie fragment box ‘moof’. It also includes the beginning of the media data box ‘mdaf’ (i.e. its box header comprising its four-character code and the size) and the data corresponding to the first IDR frame (reference 1105).

The level value assigned to this first byte range is set to one since the byte range begins with a top-level box and contains independently decodable media data (SAP 1, 2, or 3). The second byte range between the two IDR frames is composed of predictively coded P-frames that depends on the decoding of the first IDR frame. Any level value N greater than two can be used to identify this byte range. The level value indicates that this byte range may depend on preceding byte ranges with level value smaller than N up to previous independently decodable media data, if any. The third byte range corresponds to the second IDR frame (reference 1110). It is assigned to the level value two to indicate that this byte range does not begin with a top-level box and contains independently decodable media data (SAP 1, 2, 3). The client can use this indication to jump directly to this stream access point. The fourth byte range corresponding to another set of P-frames depending on the IDR frame 1110 is assigned to a level N greater than two to signal their dependence to preceding byte ranges with level value smaller than N up to previous independently decodable media data (i.e. the IDR frame 1110).

FIG. 11b illustrates a second example of level assignment using the new version of the sub-segment index box ‘ssix’.

This example is similar to the one illustrated in FIG. 11a, except that there is an explicit range for the initial movie fragment box ‘moof’ referenced 1140 in the sub-segment 1130. This first byte range is assigned to level zero since the byte range contains exactly one or more file-level boxes and no media content data. The second byte range starts with the beginning of the media data box ‘mdat’ and includes the first IDR frame referenced 1135. As it begins with a file-level box, this second byte range including independently decodable media data is assigned to level one. Other byte ranges are handled similarly to the ones illustrated in FIG. 11a.

FIG. 11c illustrates a third example of level assignment using the new version of the sub-segment index box ‘ssix’.

This example illustrates a low latency DASH sub-segment 1160 composed of two chunks referenced 1165 and 1170 (each chunk corresponding to a media fragment). In this example, there is no explicit byte range for the initial ‘moof’. The feature type in the ‘ssix’ is set to the predefined value one (identifying dependency levels). Only the first chunk contains an IDR frame. Accordingly, the first chunk is divided into two byte ranges. The first byte range is assigned with a level one indicating that the byte range is beginning with a file-level box and contains independently decodable data (SAP 1, 2 or 3). The second byte range is assigned to a level three (i.e. to a value greater than two) because it contains dependently decodable data. A third byte range contains the complete second chunk 1170. This second chunk only contains predictively coded P-frames that depends by definition on frames of the preceding byte range. To signal this, the third byte range is assigned with level value four because its data depends on data from byte range with assigned level three.

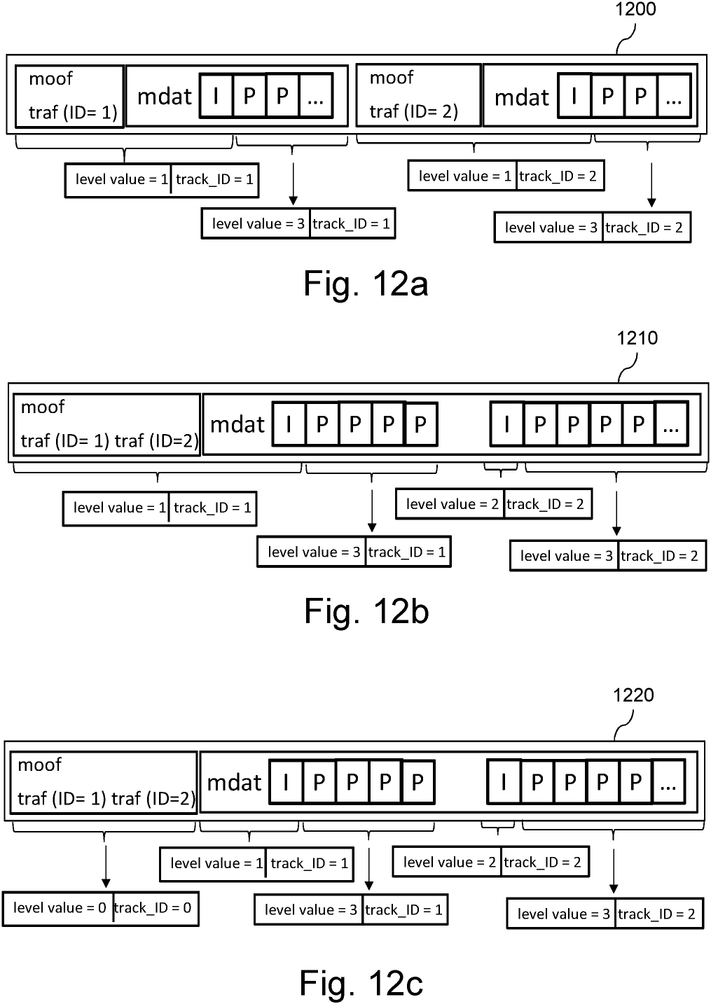

FIG. 12a, FIG. 12b, and FIG. 12c illustrate three different examples of multi-track level assignment using the new version of the sub-segment index box ‘ssix’.

In these examples, each of the three sub-segments referenced 1200, 1210, and 1220 contains data corresponding to different tracks (described by track fragment boxes ‘traf’ with track_ID=1 and track_ID=2 (noted ID=1 and ID=2 respectively in FIGS. 12a, 12b, and 12c). For example, the tracks may contain data corresponding to different media types (e.g. audio or video), different scalability layers, different temporal sub-layers, or different spatial sub-parts. The feature type in the ‘ssix’ is set to the predefined value two (identifying multi-track dependency levels).

It is noted that the level only gives dependency information within the track and not dependency information between the track.

The level value assigned to each byte range in the ‘ssix’ is divided into two parts. A first part containing the level assigned to the byte range (similar to the levels defined with feature type equal to one) and the second part containing the track identifier (track_ID) corresponding to the data of this byte range.

The track_ID within the level attribute allows the client to select byte ranges pertaining to a given track only.

As illustrated in FIG. 12a, data of each track are encapsulated in separate media fragments. The first media fragment corresponds to the track having its identifier sets to one (ID=1). The second media fragment corresponds to the track having its identifier sets to two (ID=2). There is no explicit byte range for identifying the ‘moof’s (i.e. no level zero). A byte range identifies the first IDR frame (including the ‘moof’ and header of the ‘mdat’) of each media fragment with a level set to one. The remaining dependently decodable P-frames are assigned with a level set to three (i.e. to a value greater than two) because it contains dependently decodable data.

In FIG. 12b, the data of two different tracks are multiplexed within a single media fragment. According to this example, the first sequence of I-frame and P-frames (I, P, P, etc.) corresponds to frames of a track having its identifier sets to one (ID=1) and the second sequence of I-frame and P-frames in the ‘mdat’ corresponds to frames of a track having its identifier sets to two (ID=2).

As illustrated, the first byte range includes the movie fragment ‘moof’ that is common to both tracks, but also the data of an IDR frame corresponding to data of the track having its identifier sets to one (ID=1). In such a case, the track identifier (track_ID) assigned to the byte range is set to the identifier of the track to which the data of the IDR frame belong. Accordingly, the track identifier of the first byte range is one (track_ID=1).

The example illustrated in FIG. 12c is similar to the one illustrated in FIG. 12b, except that there is an explicit byte range containing only a file-level box (the movie fragment box ‘moof’) common to multiple tracks. This byte range is assigned with the level zero. Since this movie fragment describes two tracks and the byte range does not contain any other track-specific data, the track identifier signalled in the level attribute is set to the reserved value zero.

FIG. 13 illustrates an example of signalling corrupted timed media content data according to some embodiments of the invention.

The timed media content data represent timed data units of media content data (e.g. frames or partial parts of frames of a video bitstream such as, e.g., tiles, subpictures, blocks, open bitstream units or NAL units or samples of an audio bitstream) encapsulated into a media file conformant with ISOBMFF and derived standards. Each timed media content data unit may be encapsulated as a sample or several timed media content data units may be encapsulated as a sample and stored in a data container box (e.g. MediaDataBox ‘mdat’ 1300 or IdentifiedMediaDataBox ‘imda’). FIG. 13 illustrates four samples of timed media content data of the MediaDataBox ‘mdat’ 1300: two samples 1310 and 1320 representing complete and not corrupted timed data units of timed media content data, a sample 1330 representing a lost timed data unit of timed media content data (sample size is equal to zero), and a sample 1340 representing a partially corrupted timed data unit of timed media content data.

In this example, the corruption state of each sample is signalled by defining a SampleToGroupBox ‘sbgp’ 1350 and a SampleGroupDescriptionBox ‘sgpd’ 1360, both boxes having the same grouping_type, e.g. ‘corr’, identifying a corrupted sample group.

The SampleToGroupBox ‘sbgp’ 1350 describes a sequence of groups of samples and associates with each group an index to a description entry (CorruptedSamplelnfoEntry) in the associated SampleGroupDescriptionBox ‘sgpd’ 1360. Three groups of samples are defined by the SampleToGroupBox 1350 (and noted (a), (b), (c) for the sake of illustration).

The first group is composed of two samples (sample_count = 2) 1310 and 1320 and is associated with the grouping description index 0 indicating that those samples are present and not corrupted.

The second group is composed of a single sample 1330 (sample_count = 1) and is associated with the first entry (CorruptedSamplelnfoEntry) of the SampleGroupDescriptionBox 1360. This first entry indicates that this sample has been lost (corrupted = 0), i.e. this sample has no media content data and the sample size is equal to zero.

The third group is also composed of a single sample 1340 (sample_count = 0) and is associated with the second entry (CorruptedSamplelnfoEntry) of the SampleGroupDescriptionBox 1360. This second entry indicates that this sample is corrupted (corrupted = 2) and provides codec-specific information on the type of corruption. The type of corruption can be the type of media content data that is corrupted (e.g. type of headers or type of descriptive metadata or data in the bitstream). As illustrated, two flag values (SEICorruptedFlag and ParameterSetCorruptedFlag) are set in the bit-mask codec specific_param indicating that at least one SEI NAL unit and at least one Parameter set NAL unit are corrupted in the associated sample.

FIG. 14 is a block diagram illustrating an example of steps carried out by a processing device to generate a media file comprising corrupted timed media content data according to some embodiments of the invention.

As illustrated, a first step 1400 is directed to obtaining a plurality of timed media content data units that may suffer from loss or data corruption during the obtaining step. For example, this may happen when a media bitstream is received from an error-prone network using a non-reliable protocol (e.g. Real-time protocol (RTP) or File Delivery over Unidirectional Transport (FLUTE)). This may also happen when a media bitstream is read from a corrupted file storage.

At step 1410, it is determined whether at least one timed media content data unit is lost or corrupted. This can be determined by parsing the obtained media content data in order to detect missing data or syntax errors in the bitstream. This can also be determined by information provided by the storage device, the network or the transport protocol (e.g. RTCP feedbacks, checksum failure, Forward Error Correction failure, missing packets, etc.).

If a data corruption or loss is detected at step 1410, a first indication is generated at step 1420 to signal whether the timed media content data is either fully lost or partially corrupted (e.g. as illustrated by ‘corrupted’ parameter in FIG. 13).

At step 1430, a second indication is generated to provide codec specific information on the type of corruption or type of media content data (e.g. as illustrated by ‘codec_specific_param’ parameter in FIG. 13).

At step 1440, the obtained plurality of timed media content data units and first and second indications are encapsulated into a media file, e.g. according to ISOBMFF or a ISOBMFF-based or derived specification.

FIG. 15 is a block diagram illustrating an example of steps carried out by a processing device to process a media file comprising corrupted timed media content data according to some embodiments of the invention.

As illustrated, a first step 1500 is directed to obtaining a media file comprising a plurality of timed media content data units. The media file can be obtained by reading it on a storage device or by receiving it from the network (e.g. using a TCP or UDP based protocol).

At step 1510, it is checked whether there is a first indication signalling that at least one timed media content data unit of the plurality of timed data units is corrupted or lost. The first indication may be obtained by parsing the descriptive metadata of the media file (e.g. the MovieBox ‘moov’ of an ISOBMFF file).

At step 1520, after having obtained a first indication indicating that at least one timed media content data unit of the plurality of timed data units is corrupted, a second indication is obtained, this second indication providing codec specific information on the type of corruption (or type of media content data that is corrupted).

At step 1530, it is determined whether the processing to be performed on the plurality of timed media content data units is resilient to the type of corruption (for example, loss of a slice header of a NAL unit), i.e. whether the corrupted data can be recovered during the processing or cannot be recovered. The processing can correspond to a parsing, a decoding or display of the bitstream represented by the plurality of timed media content data units.

At step 1540, if it is determined that the processing may be resilient to signalled types of corruption, the media file is de-encapsulated and the plurality of timed media content data units are processed.

The second indication is useful to avoid starting the processing of corrupted timed media content data when the types of corruption cannot be recovered by the processing.

Therefore, according to these embodiments, the invention provides a method for encapsulating timed media content data, the timed media content data comprising a plurality of timed media content data units, the method being carried out by a server and comprising:
obtaining the plurality of timed media content data units,
determining that at least one timed media content data unit of the plurality of timed media content data units is corrupted or that at least one timed media content data unit is missing from the plurality of timed media content data units,
upon determining that at least one timed media content data unit is corrupted or is missing, generating an indication signalling that at least one timed media content data unit is corrupted or is missing, and
encapsulating the obtained timed media content data units and the generated indication,
wherein the generated indication is a parameter of a sample group of a predetermined type, according to ISOBMFF or any ISOBMFF derived specification.

According to some embodiments, the generated indication is a first generated indication, the method further comprising generating a second indication upon determining that at least one timed media content data unit is corrupted, the second indication being a parameter of the sample group of the predetermined type, according to ISOBMFF or any ISOBMFF derived specification, signalling a type of corruption. The type of corruption may depend on a codec used to encode the timed media content data units. A second indication may be generated for each corrupted timed media content data unit.

According to some embodiments, a timed media content data unit is a sample, a frame, a tile, a subpicture, a block, an open bitstream unit, or a NAL unit.

Still according to some embodiments, the sample group of the predetermined type comprises the number of timed media content data units that are not lost and not corrupted, the number of timed media content data units that are lost, the number of timed media content data units that are corrupted and that are associated with a second indication, and/or the number of timed media content data units that are corrupted and that are not associated with a second indication.

Still according to the embodiments described above, the invention provides a method for processing encapsulated timed media content data, the timed media content data comprising a plurality of timed media content data units, the method being carried out by a client and comprising:
obtaining timed media content data units from the encapsulated timed media content data,
obtaining, from the encapsulated timed media content data, an indication signalling that at least one timed media content data unit of the obtained timed media content data units is corrupted or that at least one timed media content data unit is missing from the obtained timed media content data units,
processing the obtained timed media content data units as a function of the obtained indication to generate a media bitstream complying with a predetermined standard,
wherein the generated indication is a parameter of a sample group of a predetermined type, according to ISOBMFF or any ISOBMFF derived specification.

According to some embodiments, the obtained indication is a first obtained indication, the method further comprising obtaining a second indication, the second indication being a parameter of the sample group of the predetermined type, according to ISOBMFF or any ISOBMFF derived specification, signalling a type of corruption, the obtained timed media content data units being processed as a function of the obtained first and second indications to generate a media bitstream complying with a predetermined standard. The type of corruption may depend on a codec used to encode the timed media content data units. A second indication may be obtained for each corrupted timed media content data unit.

According to some embodiments, a timed media content data unit is a sample, a frame, a tile, a subpicture, a block, an open bitstream unit, or a NAL unit.

Still according to the embodiments described above, the invention provides a computer program product for a programmable apparatus, the computer program product comprising a sequence of instructions for implementing each of the steps of the method described above when loaded into and executed by the programmable apparatus.

Still according to the embodiments described above, the invention provides a non-transitory computer-readable storage medium storing instructions of a computer program for implementing each of the steps of the method described above.

Still according to the embodiments described above, the invention provides a device for encapsulating timed media content data or processing encapsulated timed media content data, the device comprising a processing unit configured for carrying out each of the steps of the method described above.

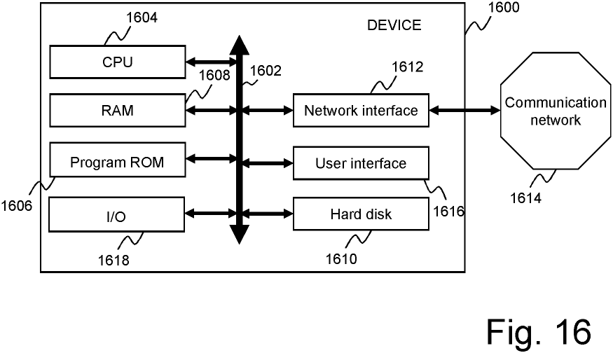

FIG. 16 is a schematic block diagram of a computing device 1600 for implementation of one or more embodiments of the invention. The computing device 1600 may be a device such as a micro-computer, a workstation, or a light portable device. The computing device 1600 comprises a communication bus 1602 connected to:
a central processing unit (CPU) 1604, such as a microprocessor;
a random access memory (RAM) 1608 for storing the executable code of the method of embodiments of the invention as well as the registers adapted to record variables and parameters necessary for implementing the method for encapsulating, indexing, de-encapsulating, and/or accessing data, the memory capacity thereof can be expanded by an optional RAM connected to an expansion port for example;
a read only memory (ROM) 1606 for storing computer programs for implementing embodiments of the invention;
a network interface 1612 that is, in turn, typically connected to a communication network 1614 over which digital data to be processed are transmitted or received. The network interface 1612 can be a single network interface, or composed of a set of different network interfaces (for instance wired and wireless interfaces, or different kinds of wired or wireless interfaces). Data are written to the network interface for transmission or are read from the network interface for reception under the control of the software application running in the CPU 1604;
a user interface (UI) 1616 for receiving inputs from a user or to display information to a user;
a hard disk (HD) 1610; and/or
an I/O module 1618 for receiving/sending data from/to external devices such as a video source or display.

The executable code may be stored either in read only memory 1606, on the hard disk 1610 or on a removable digital medium for example such as a disk. According to a variant, the executable code of the programs can be received by means of a communication network, via the network interface 1612, in order to be stored in one of the storage means of the communication device 1600, such as the hard disk 1610, before being executed.

The central processing unit 1604 is adapted to control and direct the execution of the instructions or portions of software code of the program or programs according to embodiments of the invention, which instructions are stored in one of the aforementioned storage means. After powering on, the CPU 1604 is capable of executing instructions from main RAM memory 1608 relating to a software application after those instructions have been loaded from the program ROM 1606 or the hard-disc (HD) 1610 for example. Such a software application, when executed by the CPU 1604, causes the steps of the flowcharts shown in the previous figures to be performed.

In this embodiment, the apparatus is a programmable apparatus which uses software to implement the invention. However, alternatively, the present invention may be implemented in hardware (for example, in the form of an Application Specific Integrated Circuit or ASIC).

Although the present invention has been described hereinabove with reference to specific embodiments, the present invention is not limited to the specific embodiments, and modifications will be apparent to a person skilled in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method for encapsulating media data, the media data comprising metadata and data associated with the metadata, the metadata being descriptive of the associated data, the media data comprising a plurality of segments, at least one segment comprising a plurality of sub-segments, the method being carried out by a device and comprising:
for a plurality of byte ranges of at least one of the sub-segments, associating one level value with each byte range within metadata descriptive of partial sub-segments of the at least one of the sub-segments,
wherein the metadata descriptive of partial sub-segments of the at least one of the sub-segments further comprise a feature type value representative of features associated with level values.

2. The method of claim 1, wherein a same level value is associated with at least two non-contiguous byte ranges of the at least one of the sub-segments.

3. The method of claim 1, wherein the feature type value indicates that the features associated with level values are defined within metadata descriptive of data of the segments.

4. The method of claim 1, wherein the feature type value indicates that the level values are representative of dependency levels.

5. The method of claim 1, wherein the feature type value indicates that the level values are representative of track dependency levels.

6. The method of claim 5, wherein a track identifier is associated with a level value.

7. The method of claim 4, wherein a first level value indicates that the corresponding byte range contains only metadata.

8. The method of claim 4, wherein a second level value indicates that the corresponding byte range comprises metadata and data, the data being independently decodable.

9. The method of claim 4, wherein a third level value indicates that the corresponding byte range contains only data that are independently decodable.

10. The method of claim 4, wherein a fourth level value indicates that the data of the corresponding byte range require data of a byte range associated with a lower level value to be decoded.

11. The method of claim 1, wherein the feature type value indicates that the level values are representative of data integrity of data of the corresponding byte range.

12. The method of claim 4, wherein the metadata descriptive of partial sub-segments of the at least one of the sub-segments further comprise a flag indicating that an end portion of a byte range can be ignored for decoding the encapsulated media data.

13. The method of claim 1, wherein the feature type value is a first feature type value, the at least one of the sub-segments being referred to as a first sub-segment, metadata descriptive of partial sub-segments of the sub-segments further comprising a second feature type value representative of features associated with level values of a second sub-segment of the at least one segment, different from the first sub-segment.

14. The method of claim 1, wherein the metadata descriptive of partial sub-segments of the at least one of the sub-segments belong to a box of the ‘ssix’ type, the media data being encapsulated according to ISOBMFF.

15. The method of claim 3, wherein the metadata descriptive of data of the segments belong to a box of the ‘leva’ type.

16. The method of claim 1, wherein the media data comprises a plurality of segments, at least one segment comprising a plurality of sub-segments.

17. A method for processing received encapsulated media data, the media data comprising metadata and data associated with the metadata, the metadata being descriptive of the associated data, the media data comprising a plurality of segments, at least one segment comprising a plurality of sub-segments, the method being carried out by a device and comprising:
for a plurality of byte ranges of at least one of the sub-segments, the byte ranges being defined in metadata descriptive of partial sub-segments of the at least one of the sub-segments, obtaining one level value associated with each byte range within the metadata descriptive of partial sub-segments of the at least one of the sub-segments,
obtaining a feature type value representative of features associated with level values, the feature type value being obtained from the metadata descriptive of partial sub-segments of the at least one of the sub-segments, and
processing byte ranges of the plurality of byte ranges according to a feature determined from the obtained feature type value.

18. (canceled)

19. (canceled)

20. (canceled)

21. A device for encapsulating media data, the media data comprising metadata and data associated with the metadata, the metadata being descriptive of the associated data, the media data comprising a plurality of segments, at least one segment comprising a plurality of sub-segments, the device comprising a processing unit configured for carrying out the following steps:
for a plurality of byte ranges of at least one of the sub-segments, associating one level value with each byte range within metadata descriptive of partial sub-segments of the at least one of the sub-segments,
wherein the metadata descriptive of partial sub-segments of the at least one of the sub-segments further comprise a feature type value representative of features associated with level values.

22. A device for processing received encapsulated media data, the media data comprising metadata and data associated with the metadata, the metadata being descriptive of the associated data, the media data comprising a plurality of segments, at least one segment comprising a plurality of sub-segments, the device comprising a processing unit configured for carrying out the following steps:
for a plurality of byte ranges of at least one of the sub-segments, the byte ranges being defined in metadata descriptive of partial sub-segments of the at least one of the sub-segments, obtaining one level value associated with each byte range within the metadata descriptive of partial sub-segments of the at least one of the sub-segments;
obtaining a feature type value representative of features associated with level values, the feature type value being obtained from the metadata descriptive of partial sub-segments of the at least one of the sub-segments; and
processing byte ranges of the plurality of byte ranges according to a feature determined from the obtained feature type value.
